(19) United States
(12) Patent Application Publication
(10) Pub. No.: US 2025/0086939 A1
(43) Pub. Date: Mar. 13, 2025

(54) Image Recognition for the Identification of Incorrect Items

(71) Applicant: Maplebear Inc., San Francisco, CA (US)

(72) Inventors: Benjamin Knight, Oakland, CA (US); Kenneth Jason Sanchez, Orange, CA (US); Christopher Billman, Chicago, IL (US); Rebecca Riso, Croton-On-Hudson, NY (US); Matthew Negrin, Brooklyn, NY (US); Licheng Yin, Mississauga (CA)

(21) Appl. No.: 18/885,173

(22) Filed: Sep. 13, 2024

Related U.S. Application Data
(60) Provisional application No. 63/538,248, filed on Sep. 13, 2023.

(51) Int. Cl. G06V 10/764; G06Q 30/0601; G06V 10/74; G06V 10/774; G06V 10/82; G06V 20/68

(52) U.S. Cl. CPC G06V 10/764; G06Q 30/0635; G06V 10/74; G06V 10/774; G06V 10/82; G06V 20/68

(57) ABSTRACT

An online system may prompt a shopper to capture one or more images of items on a checkout belt of a retailer, wherein the items are for fulfilling orders for one or more users of an online service. An online system may provide the one or more images to a machine learning model configured to classify an item as a product. An online system may classify the items to one or more products by applying the machine learning model to the images. An online system may for each user, matching the classified products to the user's order. An online system may obtain an annotated image of the items highlighting classified products which do not match the user's order. An online system may provide to the shopper the annotated image with a notification of a potential discrepancy.

### CROSS-REFERENCE TO RELATED APPLICATIONS

This application claims the benefit of U.S. Provisional Patent Application No. 63/538,248, filed on Sep. 13, 2023, which is incorporated herein by reference in its entirety.

### BACKGROUND

An online system receives and processes orders from users and coordinates with pickers to fulfill the orders at retailers. Often times, pickers pick baskets for multiple users concurrently at a given retailer. It can be tricky to ensure that items intended for customer A do not mix with customer B's items and vice versa. When errors occur, the result can lead to suboptimal user satisfaction and appeasement. On top of this issue, there is also a risk of the user's order being modified without the user's approval.

### SUMMARY

In one or more embodiments, this disclosure pertains to a method which includes a plurality of steps. The steps include a step of providing to a client device of a picker a prompt to capture one or more images of items that are for fulfilling orders for one or more users of an online system. The steps further include a step of providing the one or more images to a machine learning model configured to classify an item in an image to a product. The steps further include a step of classifying, by applying the machine learning model to the images, the items to one or more products. The steps further include a step of, for each of the one or more users, matching the classified items to the user's order. The steps further include a step of obtaining an annotated image highlighting one or more classified items which do not match the user's order. And the steps further include a step of providing the annotated image to the client device of the picker.

In one or more embodiments, this disclosure pertains to a method which includes a plurality of steps. The steps include a step of providing to a client device of a picker a prompt to capture one or more images of items in a delivery. The items are for fulfilling an order for a user of an online service, and where the prompt is based on an estimated risk of an error in contents of the delivery matching the order. The steps further include a step of providing the one or more images to a machine learning model configured to classify each item as a product. The steps further include a step of classifying, by applying the machine learning model to the images, the items to one or more products. The steps further include a step of matching the classified items to the user's order. The steps further include a step of obtaining an annotated image highlighting classified items which do not match the user's order. And the steps further include a step of providing the annotated image to the client device of the picker.

### BRIEF DESCRIPTION OF THE DRAWINGS

FIG. 1A illustrates an example system environment for an online system, in accordance with some embodiments.

FIG. 1B illustrates an example system environment for an online system, in accordance with some embodiments.

FIG. 2 illustrates an example system architecture for an online system, in accordance with some embodiments.

FIG. 3 illustrates a block diagram of an item identification module for an online system, in accordance with some embodiments.

FIG. 4A illustrates an image captured by the shopper on a checkout belt, in accordance with some embodiments.

FIG. 4B illustrates an image where a model has identified items as products, in accordance with some embodiments.

FIG. 4C illustrates an annotated image highlighting a wrong item for a user, in accordance with some embodiments.

FIG. 5 is a flowchart for a method of identifying incorrect items included in an order of a user, in accordance with some embodiments.

FIG. 6 is a flowchart for a method of identifying incorrectly bagged items, in accordance with some embodiments.

### DETAILED DESCRIPTION

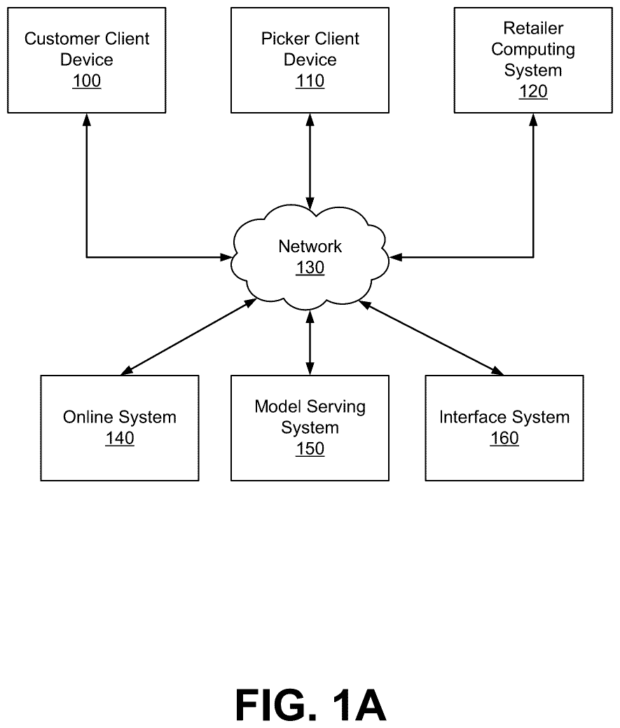

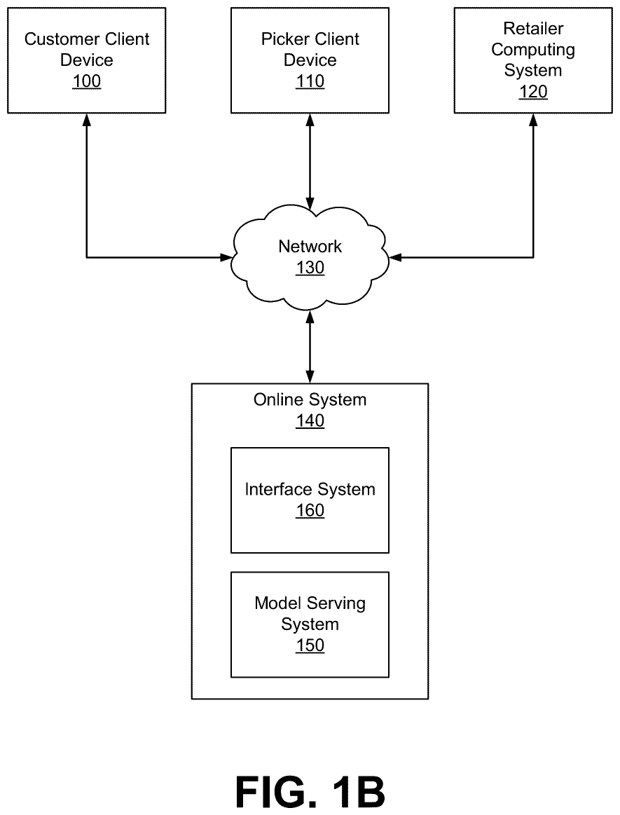

FIG. 1A illustrates an example system environment for an online system 140, in accordance with some embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be ordered by and provided to the customer through the online system 140. The order may include product identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine a product identifier encoded in a barcode coupled to an item. The picker client device 110 compares this product identifier to items or products in the order that the picker is servicing, and if the product identifier corresponds to an item in the order, the picker client device 110 identifies the item as collected. In some embodiments, rather than or in addition to using a barcode scanner, the picker client device 110 captures one or more images of the item and determines the product identifier for the item based on the images. The picker client device 110 may determine the product identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

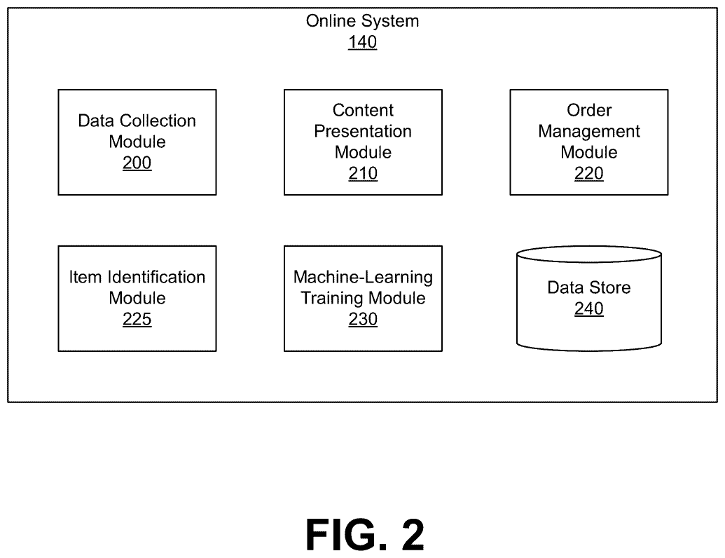

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the online system 140 receives an image or a real-time video feed (e.g., images, image data) from a shopper checking-out at a retailer while fulfilling one or more user orders (e.g., multi-order batch). For example, the images may be received via an application on the shopper's mobile or client device 110, and may correspond to images of items on a checkout belt at the point-of-sale at the retailer. In other instances, the online system 140 may receive images of items in a shopping bag after checking out at the retailer or from the delivery location during delivery. The online system 140 may be configured to identify one or more groupings of items in the images, where a grouping pertains to an order for a respective user that the shopper is attempting to fulfill and provide payment for as part of a multi-order batch. The online system 140 generates classifications of items in the images (e.g., identify a product identifier for each item in each grouping in the images), and maps the classified items to what the shopper is supposed to fulfill for each user's order. The online system 140 may then highlight incorrect items or missing items to the shopper (e.g., displayed via the application on the picker client device 110). In one or more embodiments, the model serving system 150 classifies the items as products, matches the classified items to the user's order and annotates the image of the items to highlight classified items which do not match the customer's order.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online system 140, in accordance with some embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item or product identifiers for items that are available and may include quantities of items associated with each product identifier. Additionally, item data may also include attributes of items such as the size, color, weight, stock keeping unit (SKU), or serial number for the item or product. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items or products to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and offers the orders to pickers for service based on picker data. For example, the order management module 220 offers an order to a picker based on the picker's location and the location of the retailer from which the ordered items are to be collected. The order management module 220 may also offer an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to offer an order to a picker based on a delivery timeframe requested by the customer with the order. The order management module 220 computes an estimated amount of time that it would take for a picker to collect the items for an order and deliver the ordered item to the delivery location for the order. The order management module 220 offers the order to a picker at a time such that, if the picker immediately services the order, the picker is likely to deliver the order at a time within the timeframe. Thus, when the order management module 220 receives an order, the order management module 220 may delay in offering the order to a picker if the timeframe is far enough in the future.

When the order management module 220 offers an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives product identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive product identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

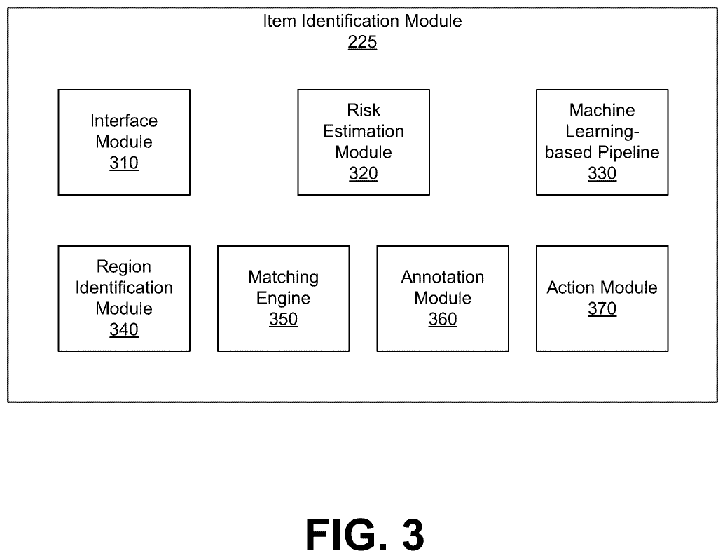

The item identification module 225 receives images of items of a multi-order batch being fulfilled by a shopper at a retailer, utilizes trained machine-learned models to classify or identify the items in the images as products, and matches the identified products to a corresponding user's order to ensure a correct set of products are being delivered for each order. Features of the item identification module 225 are described in more detail below in connection with FIGS. 3, 4A-4C, and 5-6.

FIG. 3 is a block diagram illustrating exemplary components of the item identification module 225, in accordance with some embodiments. The item identification module 225 of FIG. 3 may include an interface module 310, a risk estimation module 320, a machine learning-based pipeline 330, a region identification module 340, a matching engine 350, an annotation module 360, and an action module 370. Alternative embodiments may include more, fewer, or different components from those illustrated in FIG. 3, and the functionality of each component may be divided between the components differently from the description below. Additionally, each component may perform their respective functionalities in response to a request from a human, or automatically without human intervention.

The interface module 310 may provide to a client device (e.g., picker client device 110 in FIG. 1) a prompt to capture one or more images of items that are for fulfilling orders for one or more users of an online service (e.g., online system 140 in FIG. 1). For example, when the picker is shopping at a retailer for fulfilling one or more orders for one or more users, after the picker has picked up products per each order, the picker may proceed to the point-of-sale terminal at the store to pay for the multi-order batch and checkout. In one or more embodiments, during this checkout process, the interface module 310 may cause the application of the online system 140 installed on the picker's client device to display a notification (e.g., prompt, pop-up, and the like). The notification may ask the picker to provide the application with access to the camera function on the picker's device and capture a live, real-time image or video feed using the camera as the items of the multi-order batch are being conveyed on the conveyor belt of the point-of-sale terminal and being scanned for check-out at the retailer. That is, once the shopper has gotten to a certain step of the transaction, such as the checkout belt of a retailer, the interface module 310 prompts a shopper to capture images of items on the checkout belt of a retailer. As another example, the notification may ask the picker to capture the images using the camera function of the picker's device as the items of the multi-order batch are in a shopping cart or basket or one or more bags, before or after checkout. As another example, the notification may prompt the picker to capture separate images or a video feed of items that have been physically grouped into separate orders of the multi-order batch. The items may also all belong to a single order.

In one or more embodiments, the prompt provided by the interface module 310 to the shopper's device may be a prompt to capture one or more images of items in a delivery, where the items are for fulfilling an order for a user of an online service (e.g., online system 140 in FIG. 1). For example, the notification presented on the picker device may prompt the picker to capture images of the contents of a delivery (e.g., a shopping bag) upon delivery at the delivery location of the customer.

In one or more embodiments, the interface module 310 may provide the prompt to the picker's device to capture the one or more images in response to an estimated risk of error determined by the risk estimation module 320. The risk estimation module 320 may determine an estimated risk of error in fulfilling the order of the user. For example, if the estimated risk of error determined by the risk estimation module 320 is higher than a threshold, the risk estimation module 320 may cause the interface module 310 to generate the prompt and execute the functionality provided by the item identification module 225. If the risk is lower than the threshold, the interface module 310 may skip the prompt generation and item identification processing of the item identification module 225.

The estimated risk may indicate the chance of error in the contents of the delivery matching the order. The estimated risk may be based on previous images taken at the checkout stage before delivery, previous images taken after the checkout stage at the delivery location, the nature of the items, picker history, or other factors.

Also, the prompt generation and image capture to ensure order accuracy may be performed more than once during the delivery process. For example, the verification may be performed first at the checkout stage, when the picker is paying for the multi-order batch, and the verification may again be performed at the delivery stage, when the picker is delivering each individual order at respective delivery locations.

The interface module 310 may be configured to provide the one or more images captured in response to the prompt to a ML-based pipeline 330. The ML-based pipeline 330 may include one or more machine-learned models (e.g., one or more of the models trained by the training module 230 and stored in the data store 240 in FIG. 2; LLMs, computer vision models, and the like). The ML models may include an item classification model trained to classify an item as a product. For example, the trained ML model may be able to accept as input one or more images of items on a checkout belt, identify portions of the image that correspond to specific items, and for each of the specific items, classify the item as being a particular product the ML model is trained to detect. For each classification or identification, the ML model may output a confidence score indicating a level of confidence in the classification. For example, the ML model may output identification information (e.g., SKU, product identifier, or another unique product code) identifying a particular product in a product catalog (e.g., in the item data) or product category for each item classified or identified in the input images.

The ML model may be trained using a training set of a plurality of images of items, the images in the training set being labeled with information identifying products that match the items captured in the images. For example, the item classification model may be trained using the item data of the online system 140. The images in the training set may be, e.g., historical images of items in shopping carts, shopping bags, or laid out on the checkout or conveyor belt of at the point-of-sale terminal of a retailer. The training data may be periodically updated as new products are released or packaging of existing products is updated. The images captured by the picker client device 110 may be input to the ML model of the pipeline 330 to classify items in the images to one or more products (e.g., in a product catalog). In one or more embodiments, the ML-based pipeline 330 may generate prompts to a machine-learned model deployed or hosted by the model serving system 150 based on the captured images. The model serving system 150 is configured to classify each item in the image as a product or item having predefined identification information (e.g., product identifier, SKU).

The region identification module 340 may identify one or more image regions in the captured images as corresponding to respective groupings of items associated with respective orders in the multi-order batch being fulfilled by the picker. For example, the region identification module 340 may be a machine-learned model (e.g., image segmentation model) of the ML-based pipeline 330 that is trained to identify one or more image regions within an input image of items of a multi-order batch and segment the input image based on the identified regions. The segmented image or information regarding the one or more regions identified in the image by the region identification module 340 may then be input to the item classification model of the ML-based pipeline 330 to perform the item classification as explained above on a per-order basis. The image segmentation model may be trained using a training set of images, each image in the training set being labeled to identify known regions or segments within the image. The image segmentation model may learn weights for features based on the training set of images to be able to automatically detect regions or segments in new input images. For example, segmentation model may be trained to detect checkout dividers in images and segment image regions based on the checkout divider such that items placed on one side of a checkout divider belong to a separate group or order than items placed on the other side of the checkout divider.

The matching engine 350 matches each of the classified items received from the model serving system 150 or the item classification model with items or products in the customer's order. In one or more embodiments, there are multiple customer's orders being handled by the same shopper at once and the images of the items may include items in multiple customer's orders on the conveyor belt ready for checkout. The matching engine 350 may match each classified item to one of the customer's orders being fulfilled to the shopper, as well as whether the classified items for each order are appropriately grouped by customer.

That is, for each order, the matching engine 350 may match the classified items to the user's order. Conversely, the matching engine 350 may also determine whether a product included in the user's order has no corresponding matching classified item in the images. In response to determining that the product included in the user's order has no corresponding matching classified item in the images, the matching engine 350 may cause the interface module 310 to provide a notification to the shopper's device of a missing product that is included in the user's order but that is not fulfilled by the picker, e.g., during checkout at the retailer, or during delivery at the delivery location.

The action module 370 may determine whether to perform an action in response to the matching engine 350 determining that the classified items do not match the user's order. For example, in response to the action module 370 determining that the discrepancy annotated and displayed on the picker's device was not corrected (e.g., based on the live video feed received from the device) by the picker, the action module 370 may interact with the interface module 310 to providing to the client device of the picker another prompt to capture an image of a checkout receipt of the user's order. The checkout receipt may then be utilized by downstream workflows of the online system 140 for reconciliation and verification. For example, the downstream workflow may include manual review of the images and video feed from the picker device as well as the image of the checkout receipt.

The identification, classification, and matching of items and products as well as the corresponding annotation is associated with a confidence score. Not all outputs are equally likely to be credible enough to prompt action and notification to the customer and/or shopper. In one or more embodiments, the item identification module 225 includes thresholding logic that excludes and filters out classifications with low credibility.

The machine learning training module 230 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

In one or more embodiments, the machine learning training module 230 trains the item classification model and the image segmentation model of the ML-based pipeline 330. The image segmentation model receives an image or video and generates outputs that indicate an estimate of how to group the items captured in the image or video into two or more orders of a multi-order batch being fulfilled by the same picker. The item classification model can receive an image or video and generate outputs that indicate an estimate of which known and predefined products (e.g., SKUs) are included in the video or image. The outputs may be specified, for example, by a bounding box around each item and a label indicating the particular item name, item category, or other properties of the item. The item classification model may be trained based on a training data set including multiple instances of data instances and labels, where a data instance includes a region of an image and the label for the instance indicates what the item is or what item category it belongs to.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

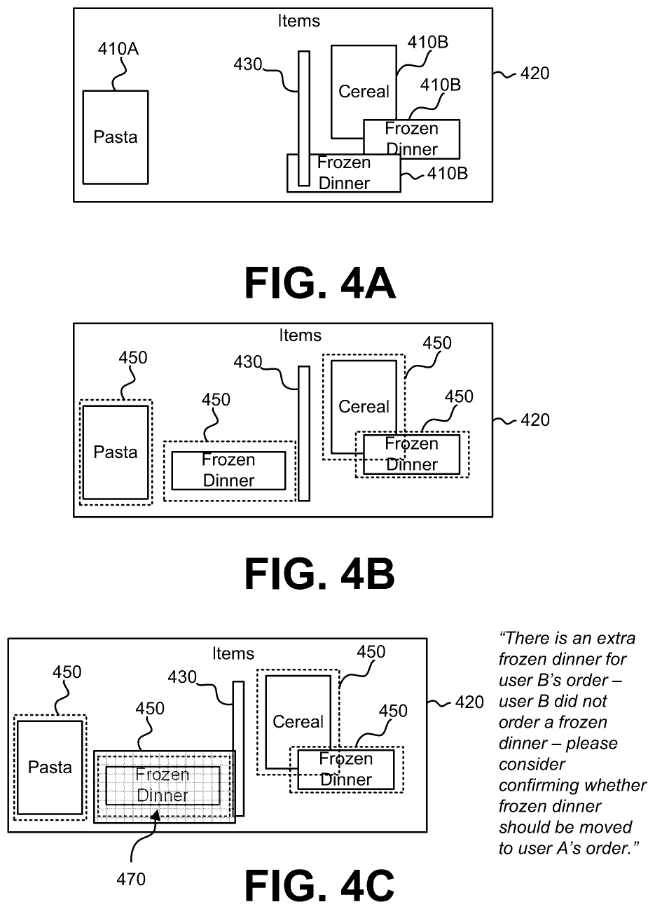

FIG. 4A illustrates an image 400 captured by the picker's client device (e.g., 110 in FIG. 1) of items 410 on a checkout belt 420, in accordance with some embodiments. FIG. 4A illustrates that the online system 140 may prompt the shopper's client device 110 to capture an image (e.g., live video feed) of items during checkout. The picker may be servicing multiple customer orders (i.e., multi-order batch) and arrive at the checkout belt 420 with items for fulfilling multiple customer orders at one time. In these cases, the shopper may group and line up the different customer orders on the checkout belt 420 and separate the different orders by, e.g., a divider 430. The items for different customers' orders may be on opposite sides of the divider as shown in FIG. 4A. When a shopper reaches this stage in the process, the interface module 310 may prompt the shopper to take the image or video 400 of the checkout belt 420 with the items being conveyed on the checkout belt 420 in order to verify that the appropriate items are placed together on the same side of the divider 430.

FIG. 4B illustrates that the annotation module 360 has identified items 410 as products, in accordance with some embodiments. As described in conjunction with FIG. 3, the annotation module 360 may interact with the interface module 310 to overlay information on the real-time image or video feed on the picker's device to identify each item in the image or video by placing color-coded bounding boxes 450 around the item and overlaying color-coded product information (not shown in FIG. 4B). The product identification is performed by the trained image classification model of the ML-based pipeline 330. As illustrated in FIG. 4B, the annotation module 360 has identified each of the items 410 as a classified item, and has classified each item as a certain product (e.g., cereal, frozen dinner, or pasta). In another instance, the outputs of the item classification model and the annotation module 360 are item names of SKU's of each item.

FIG. 4A illustrates that one side of the divider 430 includes items 410A for a first customer's order of pasta and the other side of the divider may include items 410B for a second customer's order of cereal and frozen dinners. In the example of FIG. 4A, the region identification module 340 may correctly segment the image regions that causes the ML-based pipeline 330 to correctly identify a first group of items 410A for a first customer's order (including one order of pasta), and a second group of items 410B for a second customer's order (including one order of cereal and two orders of frozen dinner), and perform order verification based on the identified groups. However, as illustrated in FIGS. 4B and 4C, if one of the two frozen dinners were inadvertently placed on the wrong side of the divider 430 by the shopper during checkout, the region identification module 340 may segment the image regions that causes the ML-based pipeline 330 to incorrectly identify a first group of items 410A for a first customer's order as including one order of pasta and one order of frozen dinner, and a second group of items 410B for a second customer's order as including one order of cereal and one order of frozen dinner.

To prompt the picker to correct this discrepancy, as shown in FIG. 4C, the annotation module 360 annotates the image 400 highlighting a wrong item 470 for the first user. That is, the annotation module 360, based on the output from the trained item classification model or model deployed on the model serving system 150, provides to the shopper an annotated version of the image highlighting the item 470 which is wrongly being grouped into the first customer's order in a user interface (UI) of the picker client device 110. Specifically, the example annotated image in FIG. 4C illustrates that the annotation module 360 highlights one of the two orders of frozen dinner which belong to the second customer and which has been grouped with the first customer's order (based on its placement on the checkout belt 420) by the region identification module 340, as a wrongly grouped item 470. In one or more embodiments, the annotation module 360 may further generate a prompt tagging the item 470 and providing associated information as overlay information on the annotated image describing the item and the discrepancy. For example, the prompt may include product identification information for the item 470 and further include identification information of the second customer or the second customer's order that includes this item 470. The prompt may help the picker in instantly and easily rectifying the error so that the items get bagged correctly for the order delivery stage of the order fulfillment process for pickers fulfilling multiple orders simultaneously.

In some instances, the shopper may provide an image or video feed after delivering a basket of items to a particular user, where the image or video feed captures the delivered baskets or bags of items. The ML-based pipeline 330 may identify items in the images using the trained item classification model, and the matching engine 350 may match the items to products in the online system's 140 product catalog for the retailer. The item identification module 225 may thus determine whether the matched items should be included in the user's order. Even though the image or video may only capture a portion of items (e.g., that are at the top part of the grocery bag or basket), this process still allows the item identification module 225 to check whether an incorrect order was delivered for the user.

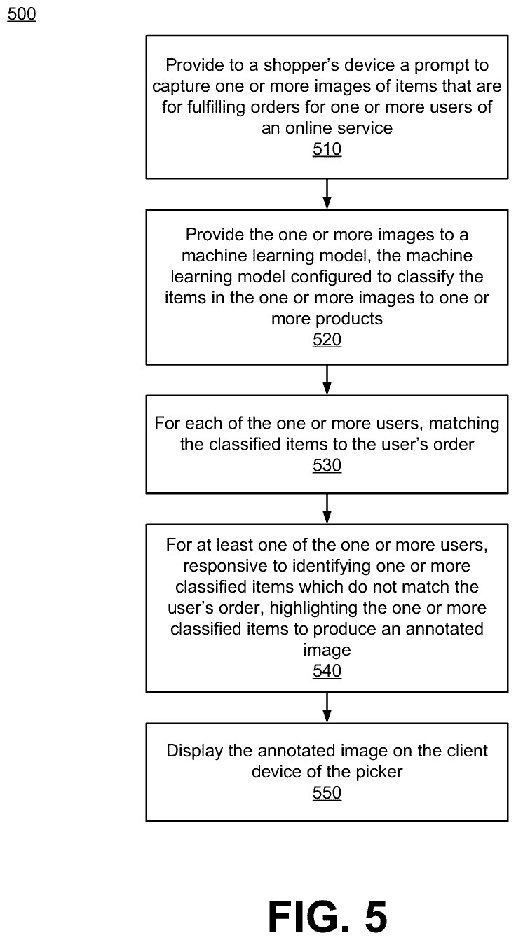

FIG. 5 is a flowchart for a method 500 of identifying incorrect items included in an order of a user, in accordance with some embodiments. Alternative embodiments may include more, fewer, or different steps from those illustrated in FIG. 5, and the steps may be performed in a different order from that illustrated in FIG. 5. These steps may be performed by an online system (e.g., online system 140). Additionally, each of these steps may be performed automatically by the online system without human intervention.

The interface module 310 may provide 510 to a picker's device (e.g., device 110) a prompt (e.g., notification, pop-up, in an application of the online system 140 running on the shopper's device) to capture one or more images (e.g., FIGS. 4A-4C) of items that are for fulfilling orders for one or more users (e.g., multi-order batch) of an online system.

The interface module 310 may provide 520 the one or more images captured at block 510 to a machine learning model (e.g., image classification model of the ML-pipeline 330) configured to classify the items in the one or more images to one or more products (e.g., identifying information like SKU associated with each item captured in the images).

For each of the one or more users, the matching engine 350 may match 530 the classified items to the user's order (e.g., match a list of product identifiers per the output of the ML model to a list of product identifiers per the order data received from the client device 100 associated with the customer). Based on the matching at block 540, for at least one of the one or more users, responsive to identifying one or more classified items which do not match the user's order, the annotation module 360 may highlight 540 the one or more classified items to produce an annotated image (e.g., FIG. 4C; 470). The interface module 310 may display 550 the annotated image (e.g., FIG. 4C; 470) on the picker's device (e.g., device 110).

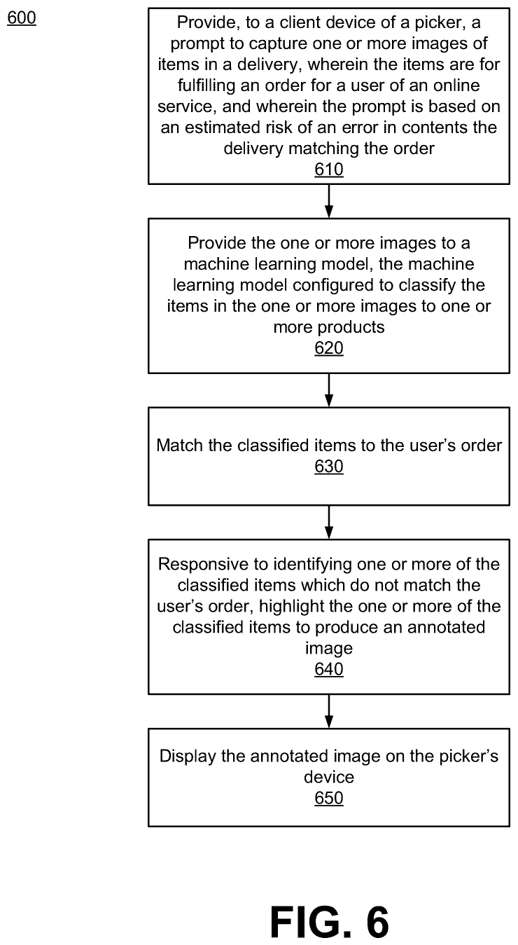

FIG. 6 is a flowchart for a method 600 of identifying incorrectly bagged items, in accordance with some embodiments. Alternative embodiments may include more, fewer, or different steps from those illustrated in FIG. 6, and the steps may be performed in a different order from that illustrated in FIG. 6. These steps may be performed by an online system (e.g., online system 140). Additionally, each of these steps may be performed automatically by the online system without human intervention.

The interface module 310 may provide 610 to a picker's device (e.g., device 110) a prompt (e.g., notification, pop-up, in an application of the online system 140 running on the shopper's device) to capture one or more images (e.g., images of contents of shopping bags at a delivery location) of items in a delivery, wherein the items are for fulfilling an order for a user of an online service (e.g., a user of the customer client device 100), and wherein the prompt is based on an estimated risk of an error in contents the delivery matching the order (e.g., features of the risk estimation module 320).

The interface module 310 may provide 620 the one or more images captured at block 610 to a machine learning model (e.g., image classification model of the ML-pipeline 330) configured to classify the items in the one or more images to one or more products (e.g., identifying information like SKU associated with the item captured in the image).

The matching engine 350 may match 630 the classified items to the user's order (e.g., match a list of product identifiers per the output of the ML model to a list of product identifiers per the order data received from the client device 100 associated with the customer).

Based on the matching at block 640, and responsive to identifying one or more of the classified items which do not match the user's order, the annotation module 360 may highlight 640 the one or more of the classified items to produce an annotated image (e.g., image of a shopping bag annotated with a bounding box and/or highlight around a mismatched item). The interface module 310 may display 650 the annotated image on the picker's device (e.g., device 110).

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
providing, to a client device of a picker, a prompt to capture one or more images of items that are for fulfilling orders for one or more users of an online system;
applying weights of a machine learning model to the one or more images to classify the items in the one or more images to one or more products;
for each of the one or more users, matching the classified items to the user's order;
for at least one of the one or more users, responsive to identifying one or more classified items which do not match the user's order, highlighting the one or more classified items to produce an annotated image; and
causing the client device to display the annotated image to the picker.

2. The method of claim 1, wherein the one or more images are images of items on a checkout belt of a retailer.

3. The method of claim 2, further comprising:
identifying a first image region of the captured one or more images, the first image region corresponding to an order of a first user;
wherein the machine learning model classifies items in the first image region to the one or more products, and wherein the method further comprises highlighting the classified items in the first image region which do not match the first user's order to produce the annotated image for the first user's order.

4. The method of claim 3, wherein the one or more images include a second image region separate from the first image region, the second image region corresponding to an order of a second user.

5. The method of claim 1, wherein highlighting the one or more classified items to produce the annotated image comprises, for the at least one of the one or more users:
identifying whether each product included in the user's order has a corresponding matching classified item in the one or more images;
in response to identifying that a product included in the user's order has no corresponding matching classified item in the one or more images, providing a notification to the client device of the picker of a missing product that is included in the user's order; and
in response to identifying that a classified item in the one or more images has no matching product in the user's order, highlighting the classified item in the annotated image.

6. The method of claim 1, wherein the machine learning model is trained using a training set of a plurality of images of items, the images in the training set being labeled with information identifying products that match the items captured in the images.

7. The method of claim 1, further comprising:
performing an action responsive to identifying, for the at least one of the one or more users, the one or more classified items which do not match the user's order.

8. The method of claim 7, wherein the action comprises at least one of:
providing haptic feedback to a device of the picker to indicate a potential error associated with the user's order; and
providing to the client device of the picker another prompt to capture an image of a checkout receipt of the user's order.

9. The method of claim 1, further comprising:
for the at least one of the one or more users, identifying an estimated risk of error in fulfilling the user's order; and
providing the prompt to capture the one or more images to the client device of the picker in response to the estimated risk of the error being higher than a threshold.

10. The method of claim 1, further comprising:
responsive to displaying the annotated image on the client device of the picker, receiving from the client device of the picker, feedback indicating that the classification by the machine learning model is incorrect; and
training the machine learning model based on the feedback.

11. A non-transitory computer-readable storage medium storing instructions that, when executed by a computer processor, cause the computer processor to perform operations comprising:
providing, to a client device of a picker, a prompt to capture one or more images of items that are for fulfilling orders for one or more users of an online system;
applying weights of a machine learning model to classify the items in the one or more images to one or more products;
for each of the one or more users, matching the classified items to the user's order;
for at least one of the one or more users, responsive to identifying one or more classified items which do not match the user's order, highlighting the one or more classified items to produce an annotated image; and
causing the client device to display the annotated image to the picker.

12. The non-transitory computer-readable storage medium of claim 11, wherein the one or more images are images of items on a checkout belt of a retailer.

13. The non-transitory computer-readable storage medium of claim 12, the operations further comprising:
identifying a first image region of the captured one or more images, the first image region corresponding to an order of a first user;
wherein the machine learning model classifies items in the first image region to the one or more products, and wherein the operations further comprise highlighting the classified items in the first image region which do not match the first user's order to produce the annotated image for the first user's order.

14. The non-transitory computer-readable storage medium of claim 13, wherein the one or more images include a second image region separate from the first image region, the second image region corresponding to an order of a second user.

15. The non-transitory computer-readable storage medium of claim 11, wherein highlighting the one or more classified items to produce the annotated image comprises, for the at least one of the one or more users:
identifying whether each product included in the user's order has a corresponding matching classified item in the one or more images;
in response to identifying that a product included in the user's order has no corresponding matching classified item in the one or more images, providing a notification to the client device of the picker of a missing product that is included in the user's order; and
in response to identifying that a classified item in the one or more images has no matching product in the user's order, highlighting the classified item in the annotated image.

16. The non-transitory computer-readable storage medium of claim 11, wherein the machine learning model is trained using a training set of a plurality of images of items, the images in the training set being labeled with information identifying products that match the items captured in the images.

17. The non-transitory computer-readable storage medium of claim 11, the operations further comprising:
performing an action in response to identifying, for the at least one of the one or more users, the one or more classified items which do not match the user's order.

18. The non-transitory computer-readable storage medium of claim 17, wherein the action comprises at least one of:
providing haptic feedback to a device of the picker to indicate a potential error associated with the user's order; and
providing to the client device of the picker another prompt to capture an image of a checkout receipt of the user's order.

19. A computer system comprising:
a computer processor; and
a non-transitory computer-readable storage medium storing instructions that, when executed by a computer processor, cause the computer processor to perform operations comprising:
providing, to a client device of a picker, a prompt to capture one or more images of items in a delivery, wherein the items are for fulfilling an order for a user of an online service, and wherein the prompt is based on an estimated risk of an error in contents the delivery matching the order;
applying weights of a machine learning model to the one or more images to classify the items in the one or more images to one or more products;
matching the classified items to the user's order;
responsive to identifying one or more of the classified items which do not match the user's order, highlighting the one or more of the classified items to produce an annotated image; and
causing the client device of the picker to display the annotated image to the picker.

20. The computer system of claim 19, wherein the one or more images are images captured at a delivery drop-off location associated with the user.
